(19) United States
(12) Patent Application Publication
(10) Pub. No.: US 2025/0040515 A1
(43) Pub. Date: Feb. 6, 2025

(54) TREAT DISPENSING PET TOY

(71) Applicant: S.Z. Enterprise S.R.L.S., Rome (IT)

(72) Inventor: Samuele Zaccato, Rome (IT)

(73) Assignee: S.Z. Enterprise S.R.L.S., Rome (IT)

(21) Appl. No.: 18/229,675

(22) Filed: Aug. 3, 2023

(51) Int. Cl. A01K 15/02

(52) U.S. Cl. CPC A01K 15/026

(57) ABSTRACT

A pet toy includes at least one body and at least one dispenser that dispenses treats, the body comprises at least two wheel forms which allow the rolling of the pet toy, the body contains at least one bridge part that connects the wheel forms, the body further comprises at least one nest corresponding to at least one groove included in the dispenser that allows the body and the dispenser to be detachably connected, the dispenser comprises at least one dispensing hole to allow filling and the dispensing of the treats.

### TECHNICAL FIELD

The invention relates to a pet toy that dispenses treats while being moved around with the interaction of pets.

### BACKGROUND

There is a wide range of pet toys such as treat dispensers, available today with many distinct functional features. Pet toys can be made from many different types of materials along with a nearly limitless number of shapes and colors. Toys are now designed for different types and sizes of animals as well as to target desired levels of interaction and activity.

These toys serve multiple purposes. They provide mental stimulation and enrichment by engaging pets in problem-solving activities. They can also help keep pets occupied and entertained, particularly when they are left alone or need to be distracted from undesirable behaviors like excessive chewing or barking. Additionally, treat dispensers can be useful for training purposes, as they allow pet owners to reinforce positive behaviors and reward their pets with treats.

When using pet toy treat dispensers, it's important to consider the size and type of treats that can be used with the toy. It's also crucial to supervise your pet during playtime to ensure they don't accidentally swallow or break parts of the toy.

Treats are often high in calories, and if used excessively or with calorie-dense treats, pet toy treat dispensers can contribute to weight gain and obesity in pets. It's crucial to monitor treat intake and ensure it fits within your pet's overall diet and health needs. Therefore, it's important to dispense the optimum amount of treat. Having multi-part dispensers may cause overeating in pets as they learn how to dismantle them and reach the treats or they may swallow these dispenser parts that result in serious problems as mentioned above. Also, having poor dispensing functionalities such as having a lid that can cover the dispensing area may cause frustration.

As a result, all the abovementioned problems have made it necessary to make an improvement in the relevant technical field.

### SUMMARY

The present invention is related to a pet toy to eliminate the abovementioned disadvantages and bring new advantages to the relevant technical field.

The object of the invention is to provide a pet toy enabling pets to realize physical actions having increased complexity in order to dispense treats.

Another object of the invention is to provide a pet toy that can be separated into multiple toys by the pet.

Another object of the invention is to provide a pet toy that is safe for pets.

Another object of the invention is to provide a pet toy that enables the pet to clean its teeth while engaging with the toy.

To achieve all the objectives mentioned above and that will emerge from the following detailed description, the present invention relates to a pet toy that dispenses treats as a response to the physical interaction of pets. An improvement of the present invention is that the pet toy includes at least one body and at least one dispenser that dispenses treats, the body comprises at least two wheel forms which allows the rolling of the pet toy, the body contains at least one bridge that connects the wheel forms, the body further comprises at least one nest corresponding to at least one groove included in the dispenser that allows the body and the dispenser to be detachably connected, the dispenser comprises at least one dispensing hole to allow filling and the dispensing of the treats. Thus, the pet toy encourages the pets to realize physical actions and increases the required healthy amount of physical activity playtime by transforming into multiple toys and eliminating the monotony of the single toy.

A possible embodiment of the invention is characterized in that the wheel form includes at least one sound emitter located in the cavity that emits sound for further engagement for pets. Thus, the sound emitter can serve as an additional intriguing feature, emitting playful sounds for pets.

A possible embodiment of the invention is characterized in that to facilitate sound transmission the wheel form comprises at least one hole. Thus, the sound can be emitted clearly.

A possible embodiment of the invention is characterized in that the said holes on the wheel forms are on different axes. Thus, the sound level is protected while the wheel forms are rolling.

A possible embodiment of the invention is characterized in that to ease the insertion or removal of the dispenser, the body includes at least one stretching area. Thus, the dispenser can be squeezed out from the body and this allows the dispenser to be used as a separate pet toy.

A possible embodiment of the invention is characterized in that said nest is elliptical, and said the stretching area is located at the far ends of the ellipse. Thus, the dispenser can be mounted by stretching the nest.

A possible embodiment of the invention is characterized in that the dispenser has a one-piece structure. Thus, the dispenser can serve as a separate pet toy, and prevent choking hazards.

A possible embodiment of the invention is characterized in that the dispenser is in the form of a ball. Thus, the dispenser can also roll around.

A possible embodiment of the invention is characterized in that the dispenser at least partially comprises an elliptical or circular cross-section. Thus, the movement of the dispenser can be enhanced.

A possible embodiment of the invention is characterized in that the dispenser is in ellipsoid form or spherical form. Thus, the dispenser can perform better movement in a straight line.

A possible embodiment of the invention is characterized in that the dispenser is spherical and said groove is a recess on the circumference surface of the dispenser. Thus, the groove of the dispenser is placed on the bridge part around the nest.

A possible embodiment of the invention is characterized in that the dispensing hole is on the axis of said groove on the dispenser. Thus, while the dispenser is in the nest, the dispensing hole is not closed.

A possible embodiment of the invention is characterized in that said sound emitter essentially is a groan tube. Thus, it is possible to excite the pets during playtime.

A possible embodiment of the invention is characterized in that the said body comprises at least one first shell and at least one second shell, which are connected and form at least one cavity inside the body. Thus, a sound emitter can be placed in the cavity inside the body.

A possible embodiment of the invention is characterized in that the first shell and the second shell are connected inseparably. Thus, the pet toy can have a longer life and prevent any choking hazards that may occur.

A possible embodiment of the invention is characterized in that the toy contains at least one cleaner to clean the teeth of pets. Thus, the pet toy cleans the teeth of the pets while playing.

A possible embodiment of the invention is characterized in that said cleaner is in the form of flexible protrusions. Thus, the pet's teeth are protected.

A possible embodiment of the invention is characterized in that the cleaner is on the wheel form, bridge part, and dispenser. Thus, better cleaning of the teeth of the pet is ensured.

A possible embodiment of the invention is characterized in that the body and the dispenser are comprised of natural rubber. Thus, a resistant and chew-proof pet toy can be achieved.

### BRIEF DESCRIPTION OF THE DRAWINGS

FIG. 1 gives a representative isometric view of the pet toy.

FIG. 2 gives a representative exploded view of the pet toy.

FIG. 3 gives a representative upper view of the pet toy.

FIG. 4 gives a representative front view of the pet toy.

FIG. 5 gives a representative front view of the body of the pet toy.

FIG. 6 gives a representative isometric view of the dispenser of the pet toy.

FIG. 7 gives a representative side view of the dispenser of the pet toy.

### REFERENCE NUMBERS THAT GIVEN IN THE FIGURE

10 Pet Toy
20 Body
21 First Shell
22 Second Shell
23 Wheel Form
231 Hole
24 Nest
25 Sound Emitter
26 Cavity
27 Bridge Part
28 Stretching Area
30 Dispenser
31 Dispensing Hole
32 Groove
40 Cleaner
(x) X-Axis
(y) Y-Axis

### DETAILED DESCRIPTION OF THE EMBODIMENTS

In this detailed description, the subject of the invention is described utilizing examples only for clarifying the subject matter such that no limiting effect is created.

The present invention is a pet toy (10) for pets to interact with. For instance, said pets may be dogs.

Pet toy (10) is suitable to be rolled on the floor when interacting with pets. It further has a treat dispenser (30) which can be removed by the pet during interaction and provides further physical activity for the pet to realize. The detachable feature and the unique shape of the dispenser (30) enable the dispenser (30) to serve as a separate toy. For instance, the dispenser (30) can be used as a fetching ball.

Pet toy (10) further provides a structure that prevents choking hazards along with teeth cleaning function for pets. Pet toy (10) helps the dogs to realize physical activity while accessing treats. It further helps pets with over-eating problems by dispensing treats in a controlled manner compared to food bowls. It further helps over-eating problems by dispensing treats in a way that requires more complex physical activity by pets.

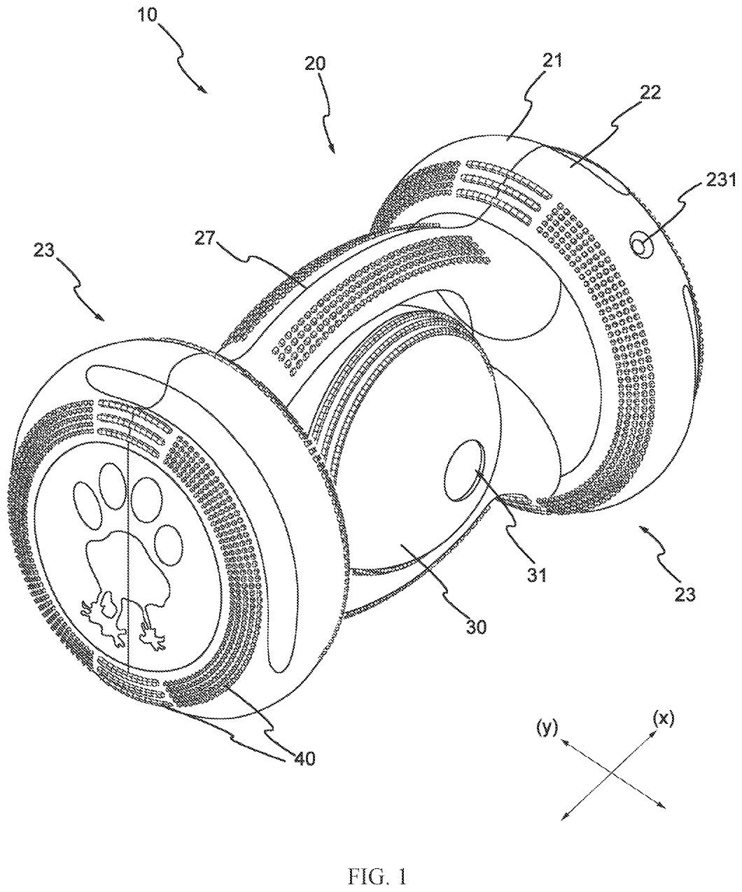

Referring to FIG. 1, the pet toy (10) includes at least one body (20). The body (20) may have a predetermined wall thickness. Said body (20) comprises at least one first shell (21) and at least one second shell (22). The first shell (21) and the second shell (22) may be connected with internal interlocking. The body (20) may be heated along the connection line of the first (21) and second shell (22) in order to strengthen the connection. In an alternative embodiment, the first shell (21) and the second shell (22) may be connected detachably. Having a wall thickness results in comprising at least one cavity (26) inside the body (20). In an alternative embodiment of the invention, the first shell (21) and the second shell (22) on the body (20) can be in the form of wire mesh. In this way, the weight of the body (20) can be reduced and less material can be used.

The connection between the first shell (21) and the second shell (22) forms at least two wheel form (23). In a preferred embodiment, the wheel forms (23) are located at both ends of the body (20). In another embodiment of the invention, the wheel form (23) can be located in any position on the body (20) that would allow the rolling of the pet toy (10). The wheel form (23) allows the pet toy (10) to be rolled around the x-axis (x) by the pet. When the wheel forms (23) are rotated around the x-axis (x), it moves linearly in the y-axis (y). In other words, the pet toy (10) realizes a rolling motion when a force is applied in a suitable direction. Therefore, by utilizing the wheel forms (23), the body (20) can be used as a separate toy as well.

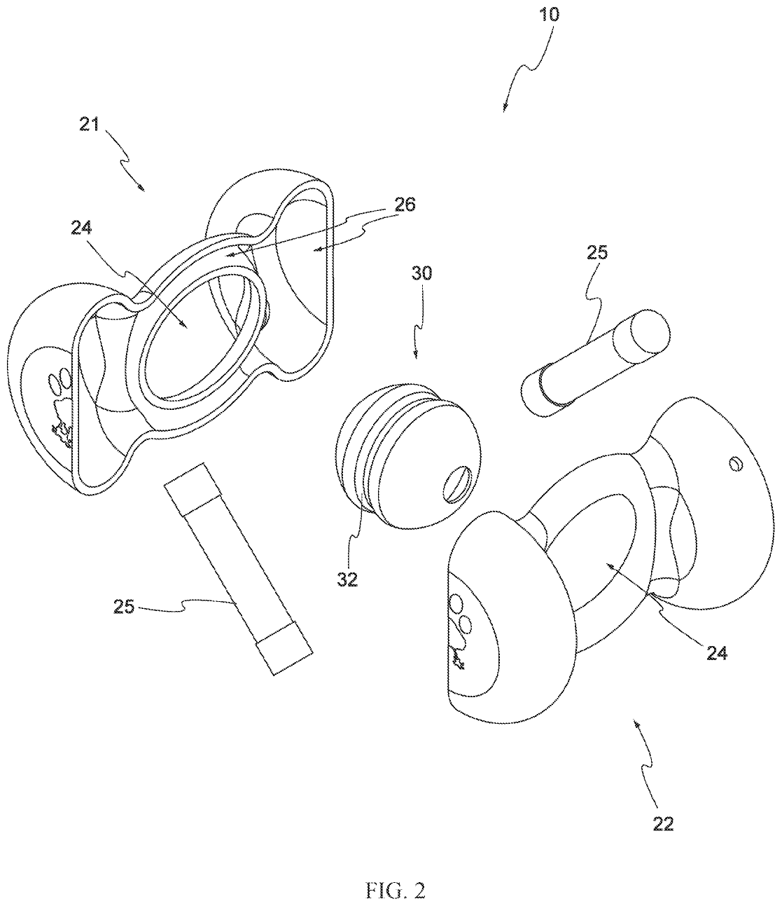

FIG. 2 gives a representative exploded view of the pet toy (10). The cavity (26) can be located inside the wheel form (23).

The wheel form (23) further comprises at least one sound emitter (25) located in the said cavity (26) inside the wheel form (23). The sound emitter (25) can serve as an additional intriguing feature, emitting stimulating sounds for pets.

Said sound emitter (25) may be fixed to the wheel form (23) by glue and therefore may be static. The length of the sound emitter (25) can be equal to the diameter of the wheel form (23) so that said sound emitter (25) can be static and doesn't move inside the cavity (26). In a preferred embodiment, the sound emitter (25) is a groan tube.

In a possible embodiment, the sound emitter (25) can be free in the cavity (26), and bounce inside the wheel form (23). Thus, as it hits the inside wall of the wheel form (23) it generates hitting sounds and decreases the uniformity of the sound. The bouncing of the sound emitter (25) in the cavity (26) also applies small impacts to the wheel form (23) while being pushed by the pet which slightly affects the direction of the pet toy (10). Which helps to reduce the monotony of the interaction.

The wheel form (23) also comprises at least one hole (231). The hole (231) allows sound transmission from the cavity (26) to outside. The holes (231) on the wheel forms (23) may be located on different axes. Thus, the sound level is protected while the wheel forms (23) are rolling.

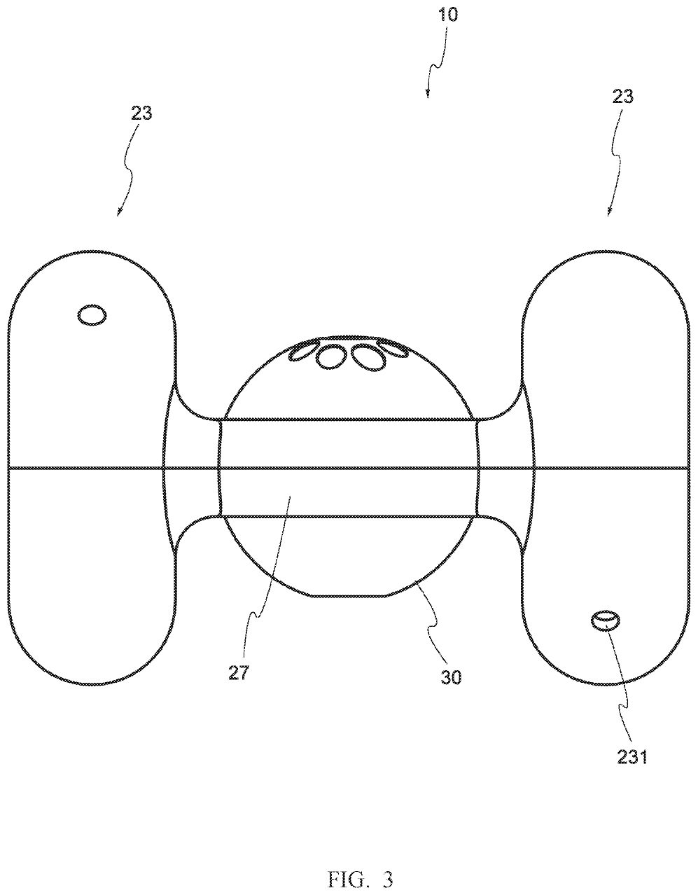

FIG. 3 gives a representative upper view of the pet toy (10). The body (20) comprises at least one bridge part (27). The bridge part (27) provided between the two wheel forms (23) and serves as a connecting part. The cavity (26) also extends along the bridge part (27). This allows to decrease the overall weight of the pet toy (10) as well as the cost.

In a possible embodiment of the invention, the sound emitter (25) can travel between wheel forms (23) by utilizing the cavity (26) inside the bridge part (27).

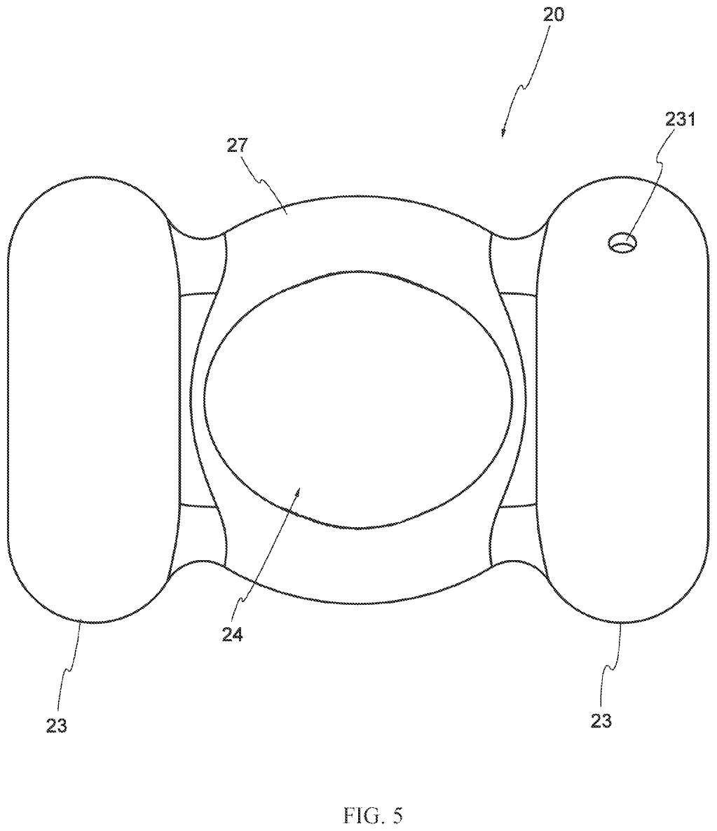

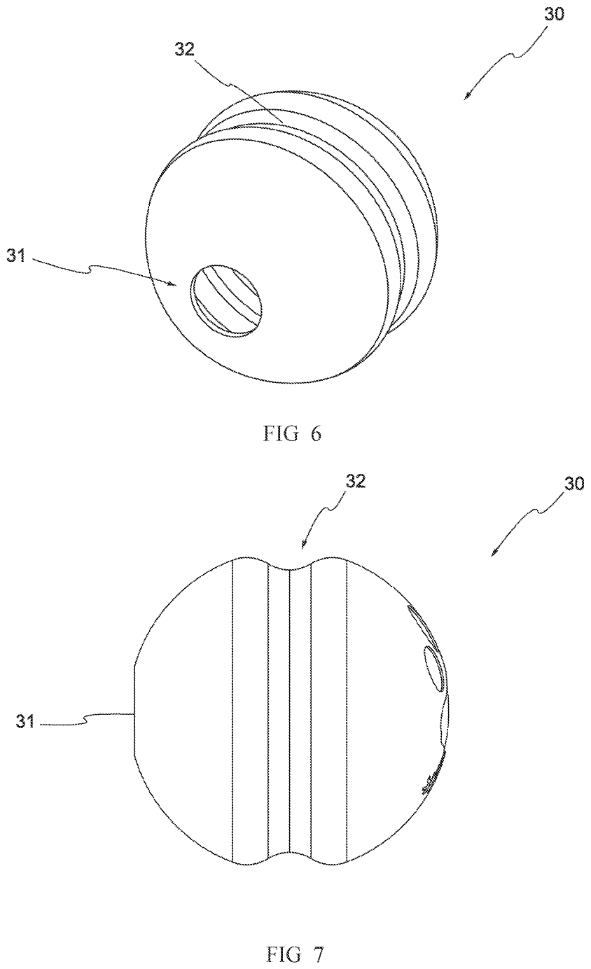

Referring to FIG. 5 the body (20) contains at least one nest (24). The nest (24) essentially is an elliptical hole. The pet toy (10) includes at least one dispenser (30) capable of storing and dispensing treats. Said nest (24) is suitable for housing the dispenser (30).

The dispenser (30) comprises at least one dispensing hole (31) that allows the filling and dispensing of the treats. In a preferred embodiment, the dispenser (30) has a spherical shape. The dispenser (30) is at least big enough to restrain pets to swallow the dispenser (30). Said dispenser (30) has at least one groove (32) on its surface that correspond to the nest (24). Groove (32) allows the dispenser (30) to be attached to a corresponding part of the nest (24).

Said groove (32) is a recess on the circumference surface of the dispenser (30). In other words, the groove (32) is in the form of a canal-circulating dispenser (30).

The dispensing hole (31) is (32) on the axis of said groove on the dispenser (30). This allows the dispenser (30) to be rotated around the y-axis (y). Therefore, in addition to the pet toy's (10) rolling along the x-axis (x), it provides better distribution of the treats and prevents blockage.

In another embodiment of the invention, the dispenser (30) may be in a shape that would allow its placement on the nest (24) such as a square, elliptical, triangle, etc. Since the dispenser (30) is detachably connected to the body (20), the dispenser (30) on its own also can be used as a pet toy (10). The dispenser (30) can be filled with food manually or using tools like a funnel through the dispensing hole (31). In a preferred embodiment dispenser (30) is in spherical form and the nest (24) is in elliptical form.

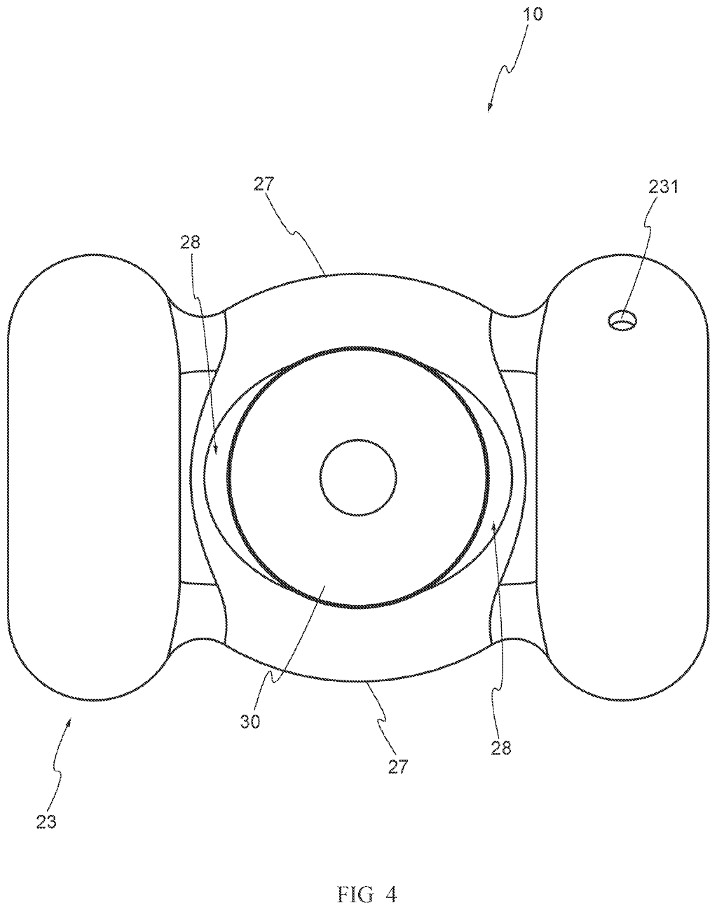

FIG. 4 gives a representative front view of the pet toy (10). In a preferred embodiment, the body (20) and the dispenser (30) consist of natural rubber. This provides resistance and chew proof to increase the lifetime of the invention and also prevents any damage that can be done to the teeth. Furthermore, it allows the dispenser (30) to be inserted in the nest (24) with a little force by elastically deforming it. The pet toy (10) includes at least one stretching area (28). The stretching area (28) is essentially a gap that would allow enough space for the dispenser (30) to be elastically enlarged while squeezed and therefore, the dispenser (30) can be removed or inserted into the nest (24). Once the groove (32) is placed on the nest (24) the dispenser (30) then again returns to its original shape and as a result, the dispenser (30) and the body (20) are connected. This way the present invention eliminates the need for connecting elements such as screws that would increase the cost and more importantly the health hazard for the pets. This area further allows the pet to squeeze out the dispenser (30) while engaging with the pet toy (10).

The pet toy (10) further comprises at least one cleaner (40) to clean the teeth of the pets while interacting. The body (20) and the dispenser (30) can comprise a plurality of cleaners (40) along their surfaces. Said cleaner (40) is essentially a flexible protrusion that covers certain areas of the pet toy's (10) surface. In an alternative embodiment of the present invention, said cleaner (40) can be rectangular or triangular in shape. Therefore, the pet toy (10) can provide a cleaning function during playtime.

In an alternative embodiment of the present invention, the material of the body (20) and the dispenser (30) can contain any material that will not harm the pet's health and provide good endurance to the structure such as BPA-free, HDPE materials, food-grade silicones or can be coated by hemp or jute.

As a result, the pet toy (10) provides a solo physical activity to engage and stimulate pets while providing them with a tasty incentive. The sound-emitting feature helps to attract their attention and increase playtime, hence, it urges pets to play along and boost their health. Furthermore, since the dispenser (30) is detachable from the body (20), in case of separation, the dispenser (30) can be rolled around by pets and the dispenser (30) can serve as a pet toy (10) as well. Additionally, after the removal of the dispenser (30), the body (20) itself can be used as a pet toy (10), since it would roll around and emit sound without the dispenser (30). For instance, it can be used as a chew toy. Therefore, the pet toy (10) is essentially comprised of multiple toys in one. This encourages the pets to increase playtime even without the treat dispensing functionality and helps with their health. Consequently, the pet toy (10) provides safe, practical, and multiple toys for pets.

The protection scope of the invention is specified in the appended claims and cannot be limited to the description made for illustrative purposes in this detailed description. Likewise, it is clear that a person skilled in the art can present similar embodiments in the light of the above descriptions without departing from the main theme of the invention.

What is claimed is:

1. A pet toy, comprising at least one body and at least one dispenser dispensing treats,
the body comprises at least two wheel forms, wherein the at least two wheel forms enable the pet toy to roll,
the body comprises at least one bridge part, wherein the at least one bridge part connects the at least two wheel forms,
the body further comprises at least one nest corresponding to at least one groove, wherein the at least one groove is comprised in the dispenser, the at least one groove allows the body and the dispenser to be detachably connected,
the dispenser comprises at least one dispensing hole to allow for filling and the dispensing of the treats.

2. The pet toy according to claim 2, wherein each of the at least two wheel forms comprises at least one sound emitter located in a cavity, wherein the at least one sound emitter emits sound for a further engagement for pets.

3. The pet toy according to claim 2, wherein to facilitate a sound transmission, each of the at least two wheel forms comprises at least one hole.

4. The pet toy according to claim 3, wherein the holes on the at least two wheel forms are on different axes.

5. The pet toy according to claim 1, wherein to ease an insertion or a removal of the dispenser, the body comprises at least one stretching area.

6. The pet toy according to claim 5, wherein the nest is in an elliptical form, and the stretching area is located at far ends of the ellipse.

7. The pet toy according to claim 1, wherein the dispenser has a one-piece structure.

8. The pet toy according to claim 1, wherein the dispenser is in a form of a ball.

9. The pet toy according to claim 1, wherein the dispenser at least partially comprises an elliptical or circular cross-section.

10. The pet toy according to claim 9, wherein the dispenser is in an ellipsoid form or in a spherical form.

11. The pet toy according to claim 1, wherein the groove is a recess on a circumference of the dispenser.

12. The pet toy according to claim 1, wherein the dispensing hole is on an axis of the groove on the dispenser.

13. The pet toy according to claim 2, wherein the sound emitter is a groan tube.

14. The pet toy according to claim 1, wherein the body comprises at least one first shell and at least one second shell, the at least one first shell and the at least one second shell are connected and form at least one cavity inside the body.

15. The pet toy according to claim 14, wherein the first shell and the second shell are connected inseparably.

16. The pet toy according to claim 1, wherein the pet toy comprises at least one cleaner to clean teeth of pets.

17. The pet toy according to claim 16, wherein the cleaner is in a form of flexible protrusions.

18. The pet toy according to claim 16, wherein the cleaner is on at least one selected from the group consisting of the wheel form, the bridge part, and the dispenser.

19. The pet toy according to claim 16, wherein the cleaner is on the at least two wheel forms, the bridge part, and the dispenser.

20. The pet toy according to claim 1, wherein the body and the dispenser are comprised of natural rubber.
